(19) United States
(12) Patent Application Publication
(10) Pub. No.: US 2024/0350847 A1
(43) Pub. Date: Oct. 24, 2024

(54) FIRE SUPPRESSION APPARATUS

(71) Applicant: Douglas Maddox, Garland, TX (US)

(72) Inventor: Douglas Maddox, Garland, TX (US)

(21) Appl. No.: 18/136,171

(22) Filed: Apr. 18, 2023

(51) Int. Cl. A62C 37/40

(52) U.S. Cl. CPC A62C 37/40

(57) ABSTRACT

A fire suppression apparatus for suppressing a fire in a room includes a housing which attaches to a surface and houses a container filled with a pressurized fire suppressant. A fire sensor monitors a room for one of a presence of a flame or a temperature above a threshold temperature. When either the presence of a flame is or the temperature above the threshold temperature is detected, a timer is started by a control circuit, which then releases the fire suppressant after the timer reaches a predetermined time period. A reset input is provided for terminating the timer and preventing the release of the fire suppressant.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire suppression devices and more particularly pertains to a new fire suppression device for suppressing a fire in a room.

### (2) Description of Related Art Including Information Disclosed Under 37 CFR 1.97 and 1.98

The prior art discloses myriad fire suppression devices which release a fire suppressant into a room when a presence of a fire is detected within the room. However, the prior art fails to describe a fire suppression device which first sounds an alarm alerting individuals to the presence of a fire, and which facilitates the prevention of the release of the fire suppressant by actuation of a reset input before a timer reaches a predetermined threshold time period.

### BRIEF SUMMARY OF THE INVENTION

An embodiment of the disclosure meets the needs presented above by generally comprising a housing with an outer wall enclosing an interior space. The housing is configured for mounting to a surface such that an end of the housing faces a room. A container is coupled to the housing and is positioned in the interior space. The container has an outlet extending through the outer wall of the housing at the end of the housing. A fire suppressant is contained under pressure in the container. A valve is coupled to the container and is positioned in a closed position with respect to the outlet. The valve is movable to an open position with respect to the outlet such that the fire suppressant is released from the container through the outlet. A control circuit is coupled to the housing and positioned in the interior space. The control circuit is electrically coupled to the valve. A sensor assembly is electrically coupled to the control circuit and includes a fire sensor that is configured for detecting one of a presence of a flame and a detected temperature above a predetermined threshold temperature in the room. The control circuit initiates a timer when the fire sensor detects one of the presence of the flame and the detected temperature. Then the control circuit directs the valve to move to the open position when the timer reaches a predetermined time period to release the fire suppressant.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fire suppression apparatus according to an embodiment of the disclosure.

FIG. 2 is a front view of an embodiment of the disclosure.

FIG. 3 is a back view of an embodiment of the disclosure.

FIG. 4 is a cross-section view of an embodiment of the disclosure taken from Arrows 4-4 in FIG. 2.

FIG. 5 is an in-use view of an embodiment of the disclosure.

FIG. 6 is a block diagram of an embodiment of the disclosure.

### DETAILED DESCRIPTION OF THE INVENTION

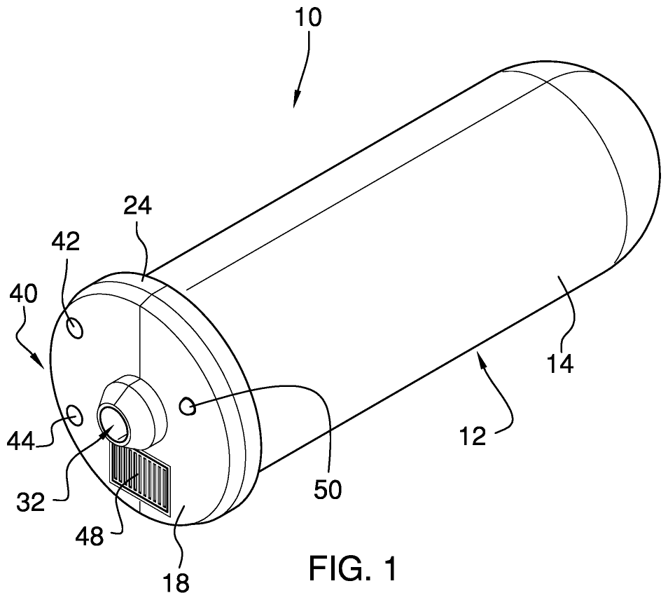

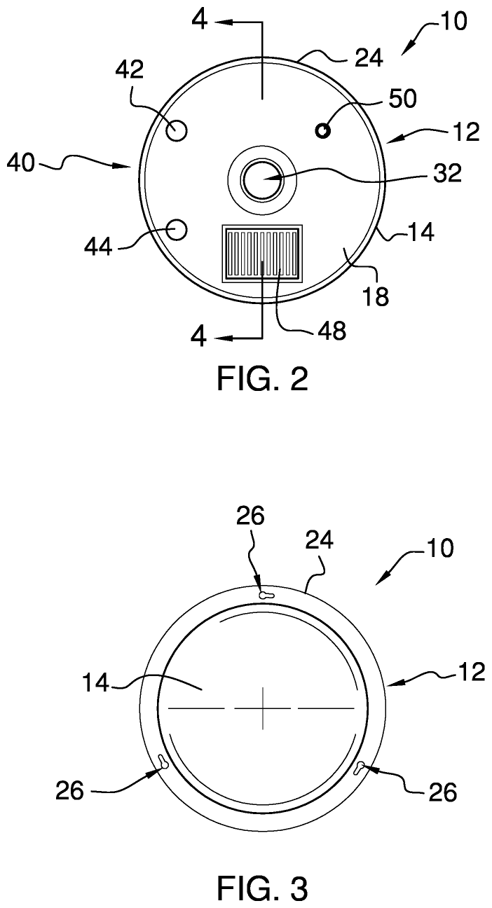

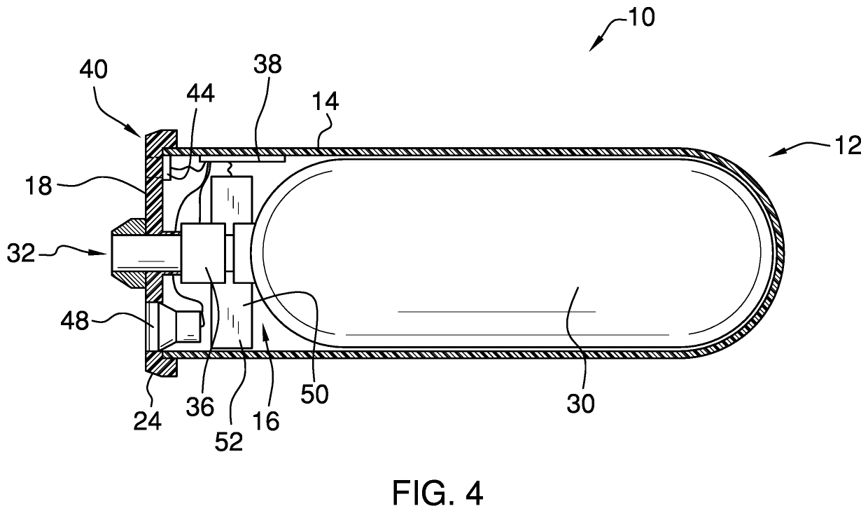

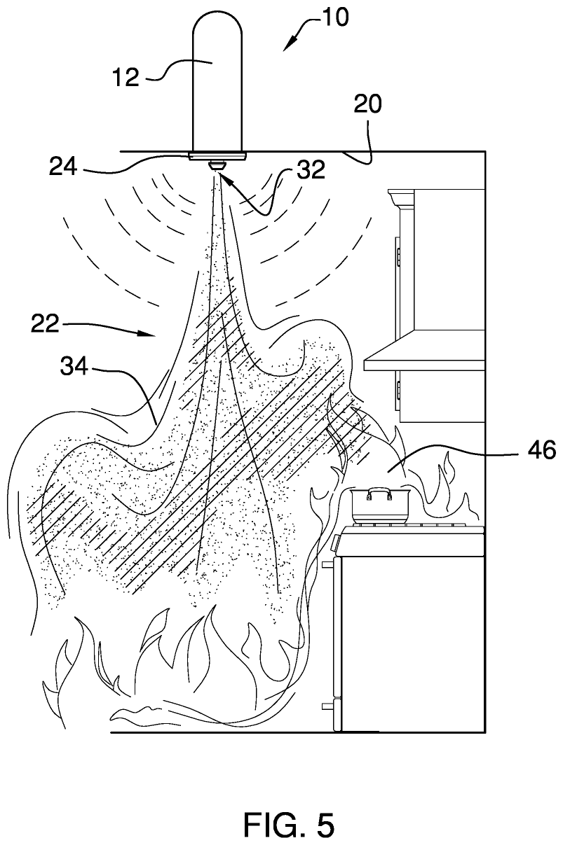

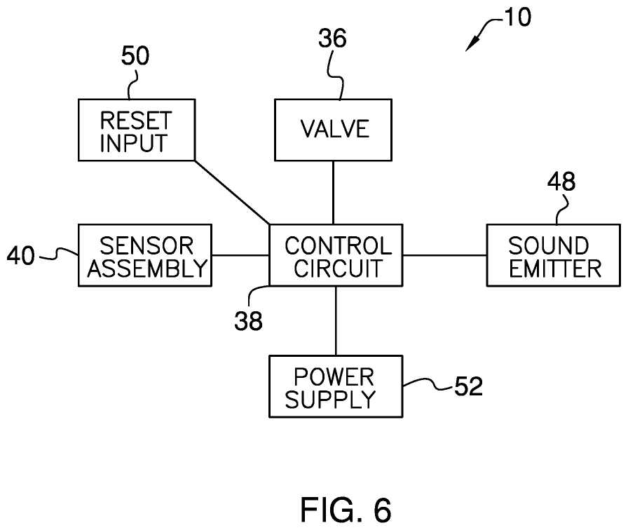

With reference now to the drawings, and in particular to FIGS. 1 through 6 thereof, a new fire suppression device embodying the principles and concepts of an embodiment of the disclosure and generally designated by the reference numeral 10 will be described.

As best illustrated in FIGS. 1 through 6, the fire suppression apparatus 10 generally comprises a housing 12 with an outer wall 14 that encloses an interior space 16. The housing 12 is configured for mounting to a surface 20 such that an end 18 of the housing 12 faces a room 22. The housing 12 includes a flange 24 which is positioned at the end 18 of the housing 12 and which includes mounting holes 26 extending therein to receive fasteners to mount the housing 12 to the surface 20. The housing 12 is positioned in an opening 28 of the surface 20 so that at least a portion of the housing 12 is positioned opposite the room 22 across the surface 20. The surface 20 may be, for example, a wall, a ceiling, or the like. The housing 12 also may be mounted to the surface 20 via a hook, a latch, a snap fit connection, or the like.

A container 30 is coupled to the housing 12 and is positioned in the interior space 16. The container 30 has an outlet 32 which extends through the outer wall 14 of the housing 12 at the end 18 of the housing 12. A fire suppressant 34 is contained under pressure in the container 30. The fire suppressant 34 may comprise monoammonium phosphate, sodium bicarbonate, water, nonflammable gases, or the like. The fire suppressant 34 also may comprise a firefighting foam such as an aqueous film forming foam, an alcohol-resistant aqueous film-forming foam, a fluorine-free foam, or the like.

A valve 36 is coupled to the container 30 and is positioned in a closed position with respect to the outlet 32. The valve 36 is movable to an open position with respect to the outlet 32 such that the fire suppressant 34 is released from the container 30 through the outlet 32. A control circuit 38 is coupled to the housing 12 and positioned in the interior space 16. The control circuit 38 is electrically coupled to the valve 36, which includes a solenoid or other electrically powered actuator for opening 28 and closing the valve 36.

A sensor assembly 40 is electrically coupled to the control circuit 38 and includes a smoke sensor 42 and a fire sensor 44. The smoke sensor 42 is configured for detecting a presence of smoke in the room 22 and comprises an optical smoke detector, ionization smoke detector, radiation smoke detector, or the like. The fire sensor 44 is configured for detecting one of a presence of a flame 46 and a detected temperature above a predetermined threshold temperature in the room 22. The fire sensor 44 may detect the presence of the flame 46 by, for example, identifying electromagnetic radiation emitted by flame 46s. The predetermined threshold temperature is set higher than room 22 temperature at a magnitude that indicates a temperature increase due to fire. The predetermined threshold temperature may, for example, be between 130 degrees Fahrenheit and 140 degrees Fahrenheit. The smoke sensor 42 and the fire sensor 44 are mounted to the outer wall 14 of the housing 12 at the end 18 of the housing 12.

The control circuit 38 initiates a timer when the fire sensor 44 detects one of the presence of a flame 46 and the detected temperature. When the timer reaches a predetermined time period, the control circuit 38 directing the valve 36 to move to the open position to release the fire suppressant 34. The predetermined time period may, for example, be between 30.0 seconds and 60.0 seconds.

A sound emitter 48 is electrically coupled to the control circuit 38 and is configured for emitting sound into the room 22. The sound emitter 48 emits a smoke alarm when the smoke sensor 42 detects the presence of smoke and emits a fire alarm when the fire sensor 44 detects one of the presence of a flame 46 and the detected temperature. The smoke alarm may be distinct from the fire alarm. The sound emitter 48 is mounted to the outer wall 14 of the housing 12 at the end 18 of the housing 12. A reset input 50 is electrically coupled to the control circuit 38 and is actuatable to terminate the timer. The reset input 50 is mounted to the outer wall 14 of the housing 12 at the end 18 of the housing 12. A power supply 52 is electrically coupled to the control circuit 38 and is positioned in the interior space 16. The power supply 52 comprises a battery 54. The control circuit 38 also may be electrically coupled to an external power source, such as a building electrical system or a utility power supply 52.

In use, the fire suppression apparatus 10 monitors the room 22 to detect smoke or fire in the room 22. When the smoke sensor 42 detects the presence of smoke, the smoke alarm is sounded by the sound emitter 48. When the fire sensor 44 detects the presence of a flame 46 or the detected temperature, the fire alarm is sounded by the sound emitter 48 and the timer is initiated by the control circuit 38. The reset input 50 may be actuated to terminate the timer and thus prevent the fire suppressant 34 from being released in the case of a false alarm or if the user manages to contain or suppress the fire by alternative means. The timer may also be terminated if the presence of a flame 46 or the detected temperature is no longer detected by the fire sensor 44 before the timer reaches the predetermined time period. If the timer reaches the predetermined time period before being terminated, the valve 36 is actuated by the control circuit 38 to open and release the fire suppressant 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire suppression apparatus comprising:
a housing having an outer wall enclosing an interior space, the housing being configured for mounting to a surface such that an end of the housing faces a room;
a container being coupled to the housing and being positioned in the interior space, the container having an outlet extending through the outer wall of the housing at the end of the housing;
a fire suppressant being contained under pressure in the container;
a valve being coupled to the container and being positioned in a closed position with respect to the outlet, the valve being movable to an open position with respect to the outlet such that the fire suppressant is released from the container through the outlet;
a control circuit being coupled to the housing and positioned in the interior space, the control circuit being electrically coupled to the valve;
a sensor assembly being electrically coupled to the control circuit, the sensor assembly including a fire sensor being configured for detecting one of a presence of a flame and a detected temperature above a predetermined threshold temperature in the room; and
wherein the control circuit initiates a timer when the fire sensor detects one of the presence of the flame and the detected temperature, the control circuit directing the valve to move to the open position when the timer reaches a predetermined time period to release the fire suppressant.

2. The apparatus of claim 1, wherein, the fire sensor is mounted to the outer wall of the housing at the end of the housing.

3. The apparatus of claim 1, further comprising a sound emitter being electrically coupled to the control circuit, the sound emitter being configured for emitting sound into the room, the sound emitter emitting a fire alarm when the fire sensor detects one of the presence of the flame and the detected temperature.

4. The apparatus of claim 1, wherein the sensor assembly further comprises a smoke sensor being configured for detecting a presence of smoke in the room, the smoke sensor being mounted to the outer wall of the housing at the end of the housing.

5. The apparatus of claim 4, further comprising a sound emitter being electrically coupled to the control circuit, the sound emitter being configured for emitting sound into the room, the sound emitter emitting a smoke alarm when the smoke sensor detects the presence of smoke, the sound emitter emitting a fire alarm when the fire sensor detects one of the presence of the flame and the detected temperature.

6. The apparatus of claim 3, wherein the sound emitter is mounted to the outer wall of the housing at the end of the housing.

7. The apparatus of claim 1, further comprising a reset input being electrically coupled to the control circuit, the reset input being actuatable to terminate the timer.

8. The apparatus of claim 7, wherein the reset input is mounted to the outer wall of the housing at the end of the housing.

9. The apparatus of claim 1, further comprising a power supply being electrically coupled to the control circuit, the power supply being positioned in the interior space.

10. The apparatus of claim 9, wherein the power supply comprises a battery.

11. A fire suppression apparatus comprising:
a housing having an outer wall enclosing an interior space, the housing being configured for mounting to a surface such that an end of the housing faces a room;
a container being coupled to the housing and being positioned in the interior space, the container having an outlet extending through the outer wall of the housing at the end of the housing;
a fire suppressant being contained under pressure in the container;
a valve being coupled to the container and being positioned in a closed position with respect to the outlet, the valve being movable to an open position with respect to the outlet such that the fire suppressant is released from the container through the outlet;
a control circuit being coupled to the housing and positioned in the interior space, the control circuit being electrically coupled to the valve;
a sensor assembly being electrically coupled to the control circuit, the sensor assembly including:
a smoke sensor being configured for detecting a presence of smoke in the room, the smoke sensor being mounted to the outer wall of the housing at the end of the housing; and
a fire sensor being configured for detecting one of a presence of a flame and a detected temperature above a predetermined threshold temperature in the room, the fire sensor being mounted to the outer wall of the housing at the end of the housing;
wherein the control circuit initiates a timer when the fire sensor detects one of the presence of the flame and the detected temperature, the control circuit directing the valve to move to the open position when the timer reaches a predetermined time period to release the fire suppressant;
a sound emitter being electrically coupled to the control circuit, the sound emitter being configured for emitting sound into the room, the sound emitter emitting a smoke alarm when the smoke sensor detects the presence of smoke, the sound emitter emitting a fire alarm when the fire sensor detects one of the presence of the flame and the detected temperature, the sound emitter being mounted to the outer wall of the housing at the end of the housing;
a reset input being electrically coupled to the control circuit, the reset input being actuatable to terminate the timer, the reset input being mounted to the outer wall of the housing at the end of the housing; and
a power supply being electrically coupled to the control circuit, the power supply being positioned in the interior space, the power supply comprising a battery.
